(19) United States
(12) Patent Application Publication
(10) Pub. No.: US 2024/0393882 A1
(43) Pub. Date: Nov. 28, 2024

(54) Apparatus for the Contactless Triggering of at Least One Function of a Motor Vehicle

(71) Applicant: Marelli Automotive Lighting Reutlingen (Germany) GmbH, Reutlingen (DE)

(72) Inventors: Stefano Alloi, Majano (DE); Davide Baccarin, Reutlingen (DE); Riccardo Anzaldi, Pfullingen (DE)

(73) Assignee: Marelli Automotive Lighting Reutlingen (Germany) GmbH, Reutlingen (DE)

(21) Appl. No.: 18/671,237

(22) Filed: May 22, 2024

(30) Foreign Application Priority Data
May 24, 2023 (DE) 102023113661.5

(51) Int. Cl. G06F 3/01; B60Q 1/00; E05F 15/73

(52) U.S. Cl. CPC G06F 3/017; B60Q 1/0023; E05F 15/73; E05F 2015/765; E05F 2015/767; E05Y 2900/531; E05Y 2900/546; E05Y 2900/55

(57) ABSTRACT

An apparatus for the contactless triggering of at least one function of a motor vehicle comprising a sensor system which is configured to recognize gestures of a user and which is configured to monitor at least a sub-area of an environment of the motor vehicle for a predetermined gesture being performed by a user of the motor vehicle and, if the sensor system recognizes a performance of the gesture, to trigger a performance of a function of the motor vehicle to be performed. The gesture may include a hand movement.

### CROSS-REFERENCE TO RELATED APPLICATIONS

The present application claims priority to and all the benefits of German Patent Application No. 102023113661.5, filed on May 24, 2023, the entire contents of which are hereby expressly incorporated herein by reference.

### BACKGROUND OF THE INVENTION

### 1. Field of the Invention

The present invention relates to an apparatus for the contactless triggering of at least one function of a motor vehicle.

### 2. Description of the Related Art

Such an apparatus is known from DE 10 2005 032 402 B3. In the known apparatus, the function is a contactless opening of a trunk of a motor vehicle. For this purpose, the area near the rear of the motor vehicle is divided into a farther zone and a closer zone in relation to the rear. Both zones are monitored optoelectronically as to whether a person moves from a position in the farther zone in a predetermined direction into the closer zone. In the farther zone, an approach of the person is initially recognized and an authorization of the person to open is checked by an automatic and wireless dialog between the motor vehicle and an encoder. The encoder is, for example, an appropriately configured electronic car key. If authorization is established and the person enters the closer zone, the motor vehicle generates a control command, with which the trunk is opened.

It is also known from DE 10 2005 032 402 B3 that the optoelectronic measuring device can be integrated into the taillamps and that the light sources of the taillamps can serve as light transmitters of the optoelectronic measuring device in addition to their function as light sources for light functions, such as brake light, taillight and possibly further signal light functions of the taillamp. The position of an approaching person can be determined using time-of-flight measurement and triangulation. If the person is not centrally behind the vehicle, this incorrect position in relation to the installation location of the sensor system of the optoelectronic measuring device can be signaled to them by lighting up only the right or left light source in each case. Both light sources lighting up indicates, and thus acknowledges, to the person that they have reached the farther zone in their approach.

There are currently essentially four further methods and apparatuses for opening a trunk lid of a motor vehicle from the outside. A first method uses a mechanical switch at the rear of the vehicle. A second method uses a switch on a vehicle key fob. A third method uses a foot movement sensor (kick sensor) arranged under the rear of the vehicle, and a fourth method uses a smartphone app.

Applications using contactless recognition of hand movements are currently only used in interiors of motor vehicles, for example to control functions of infotainment systems, such as volume adjustments, answering or ending phone calls, and so forth.

Further known methods and apparatuses have the following disadvantages: When using a mechanical switch on the trunk lock, a user must have a free hand and must touch an area of the vehicle that is generally dirty. It is also necessary for the vehicle manufacturer to attach electrical cables and electronics, which are only to be used for opening the tailgate, to the trunk lid or the associated opening in the vehicle body.

When using a switch on a vehicle key fob or on a smartphone, the user must know where the corresponding part is located. In addition, the user must grasp the vehicle key fob or smartphone, which can be difficult if their hands are not free.

The use of a foot movement sensor may be uncomfortable for the user, and there is a risk of touching a potentially dirty area of the vehicle with the foot or leg. In addition, a user who is not familiar with the vehicle may not know the position of the foot movement sensor. It is necessary for the vehicle manufacturer to attach electrical cables and electronics, which are only to be used for opening the tailgate, in the lower area of the body to the rear or front of the vehicle.

### SUMMARY OF THE INVENTION

The present invention differs from the subject matter of DE 10 2005 032 402 B3 mentioned at the beginning in that the gesture is a hand movement. In particular, the disadvantages associated with the known use of a foot movement sensor are or can thereby be avoided.

The controllability using contactless hand movements makes user-friendly interaction between a user and the vehicle for opening the trunk possible without the need to touch a dirty area or to know where the key fob or smartphone is located.

One embodiment includes locking and/or unlocking of vehicle doors and/or vehicle windows and/or sunroofs, and/or an activating of welcome effects and/or farewell effects, and/or a switching on of a reversing lamp.

It is also preferred that the function includes an opening of the tailgate using an upward hand movement.

In another embodiment, the function includes a closing of the tailgate using a downward hand movement.

In still another embodiment, the apparatus comprises a lamp or a central brake lamp or door handles or windows or a windshield or a rear-view mirror, which comprises a gesture sensor system configured to recognize the hand movement.

The apparatus may also include a motor vehicle taillamp which comprises a gesture sensor system configured to recognize the hand movement.

Furthermore, the apparatus may be configured to use semiconductor light sources of the motor vehicle taillamp to signal a position of the gesture sensor system.

By placing the gesture sensor system, which is required to perform the function, in the taillamps, there is no longer a need to run additional cables, which can only be used for this function, into areas, such as the trunk environment. Like the cables, the electronics already present in the taillamps for the light functions thereof can also be used in multiple ways by also using these electronics (microcontrollers, semiconductor light sources) to recognize hand movements used for function control.

Visual communication by the vehicle to the user is also possible, which is also referred to below as HMI (human machine interface). By using animated light effects, it is possible to communicate various information to the user, for example on the position of the sensor system used to recognize hand movements, which hand movements can be recognized by the sensor system, and whether a hand movement has been recognized by the sensor system and signal processing. This is in particular advantageous when using the invention at night.

In another embodiment, the apparatus is configured, after the hand movement, which may, for example, be an upward or downward swipe movement, has been recognized, to use one or more light sources already present for taillamp light functions of the motor vehicle taillamp, in order to signal to the user, by lighting up the light sources, that the gesture has been recognized.

The taillamp may also include a plurality of semiconductor light sources lined up along a line, as light sources for the taillamp light functions and that the apparatus is configured to switch on a plurality of the plurality of semiconductor light sources sequentially for a short time in order to produce the optical effect of a swipe movement acknowledging the recognition of a hand movement, so that the impression of the swiping movement of a bright area of the light emission surface of the taillamp is given.

The apparatus may be configured to switch on the semiconductor sources in the case of the gesture-controlled closing of the tailgate in an order that is the reverse of that in the case of the gesture-controlled opening of the tailgate.

The apparatus may also be configured to use static symbols to signal the position of the gesture sensor system and to inform the user about the available hand movements.

The apparatus may include a mini LED display that is integrated into the taillamp and that makes dynamic interaction with the user possible.

In addition, the apparatus may be configured to use static holographic 3D symbols to interact with the user.

The gesture sensor system may include a camera and/or a radar sensor and/or a LiDAR sensor and/or a time-of-flight sensor.

The gesture recognition sensor system may also include an optical infrared sensor, at least two infrared light-emitting diodes, and a sensor control unit.

In one embodiment, the gesture recognition sensor system may include a sensor sensitive to visible light, at least two light-emitting diodes with which visible light can be emitted, and a sensor control unit.

In another embodiment, the gesture recognition sensor system may include a capacitive sensor.

The apparatus may be configured to recognize a plurality of different hand movements (recognition in a plane or even in space) and thus to make it possible to trigger the performance of a plurality of different functions of the motor vehicle.

The recognition of different hand movements allows various functions to be performed selectively, such as a gesture-controlled locking and unlocking of vehicle doors, an opening and closing of windows and sunroofs, an activating of welcome effects and farewell effects, and a switching on of a reversing lamp for illumination purposes.

The plurality of functions may also at least one of the following functions: opening/closing of the tailgate, activating/deactivating of the position light or the welcome function, personalizing of the taillamp signature, interacting with the light (e.g., dimming of the lamps depending on the distance of the hand to the taillamp), in the case of the mini LED display in the taillamp: displaying information, battery charge level, weather; switching on of the reversing light in order to illuminate the area behind the car, opening/closing of the vehicle windows.

Further advantages emerge from the description and the accompanying figures.

It should be understood that the features mentioned above and those still to be explained below can be used not only in the respectively specified combinations but also in other combinations, or alone, without departing from the scope of the present invention.

### BRIEF DESCRIPTION OF THE DRAWINGS

Embodiments of the invention are shown in the drawings and explained in more detail in the following description. The figures show the following in schematic form:

FIG. 1A shows a taillamp with a hand moving in front of it;

FIG. 1B shows the object of FIG. 1A with an opening tailgate;

FIG. 2 shows a taillamp with an HMI on the basis of dedicated illuminated static symbols;

FIG. 3 shows a taillamp with an HMI on the basis of a mini LED display;

FIGS. 4A and 4B show a taillamp with an HMI on the basis of holographic symbols;

FIGS. 5A and 5B show an individual adaptation of a taillamp signature on the basis of a hand movement recognition;

FIG. 6 shows a block diagram of an optical arrangement of infrared transceiver sensors in combination with an HMI on the basis of the taillamp light function;

FIG. 7 shows a block diagram of an optical arrangement of transceiver sensors for visible light in combination with an HMI on the basis of the taillamp light function;

FIG. 8 shows a block diagram of a capacitive gesture sensor in combination with an HMI on the basis of the taillamp light function; and

FIG. 9 shows a block diagram of a time-to-flight sensor in combination with an HMI based on the taillamp light function.

### DETAILED DESCRIPTION OF THE INVENTION

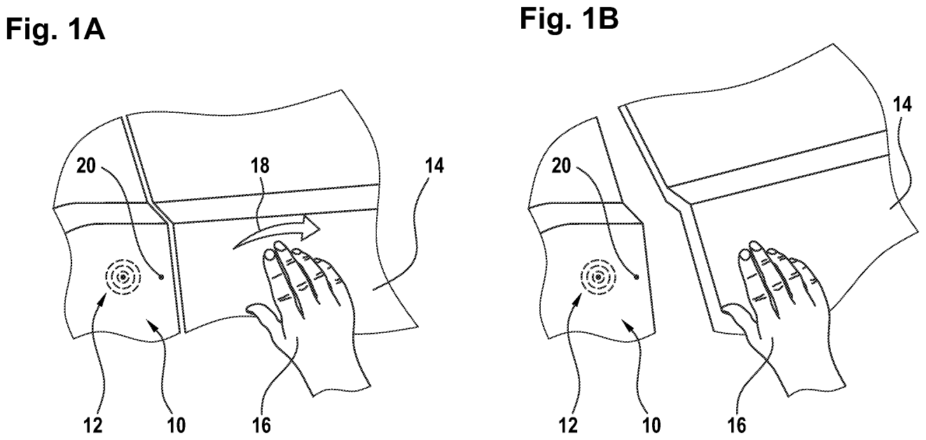

FIG. 1A shows in detail a taillamp 10 with a flashing light source 12, a closed tailgate 14 and a hand 16 of a user performing a swiping movement 18. A gesture sensor system 20 is used to detect the hand movement. FIG. 1B shows the object of FIG. 1A with a subsequently opening tailgate 14.

In this first exemplary embodiment, the semiconductor light sources of the taillamps 10 are used to initially communicate the position of the gesture sensor system 20 to the user, for example by operating one of the semiconductor light sources 12 in a pulsating, i.e., flashing, manner.

The user can then perform a hand movement 18 in front of the sensor system 20, i.e., in the detection range thereof, in order to have the vehicle perform a function assigned to the hand movement 18. In the exemplary embodiment shown in FIGS. 1A and 1B, the function is an opening of the tailgate 14. After the gesture, which can, for example, be an upward or sideways swipe movement, has been performed, one or more light sources 12 which are already present for the light functions of the taillamp 10 are used to signal to the user, by lighting up, that the gesture has been recognized.

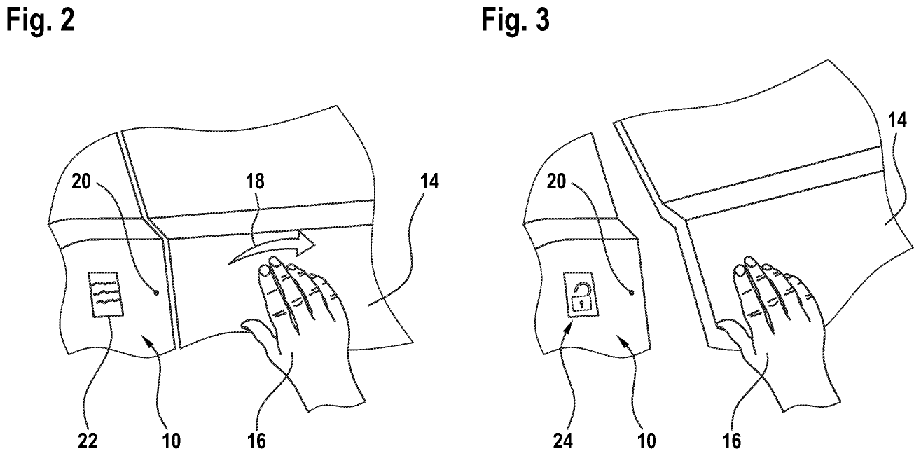

FIG. 2 shows a second exemplary embodiment. Instead of using the semiconductor light sources of the taillamps to interact with the user, static symbols 23 are used to signal the position of the gesture sensor system and to inform the user about the available gestures and their recognition.

FIG. 3 shows a third exemplary embodiment. This comprises a special, small mini LED display 24 that is integrated into the taillamp 10 and makes dynamic interaction with the user possible. The display has a large number of individually switchable LED pixels so that various symbols can be displayed in high resolution. FIG. 3 shows a symbol for an open lock, for example when the tailgate is not closed.

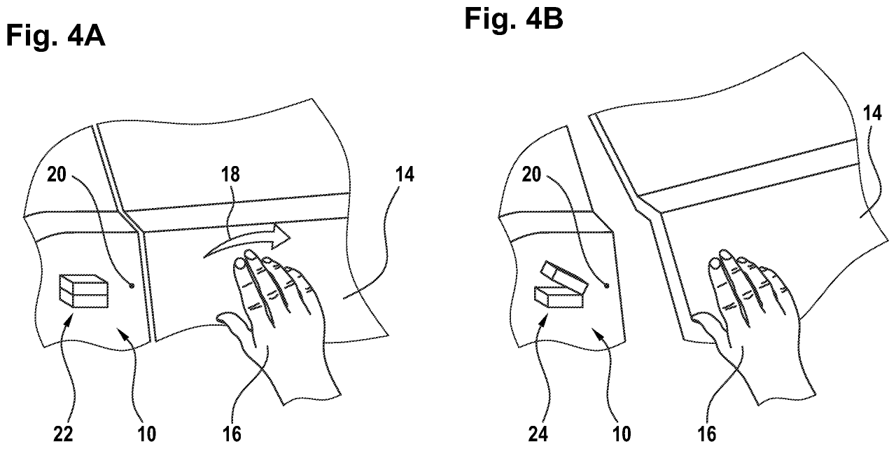

FIGS. 4A and 4B show a fourth exemplary embodiment. This exemplary embodiment is characterized in that high-quality static holographic 3D symbols are used to interact with the user. As an example, FIG. 4A shows a hologram 22 representing a closed tailgate 14, and FIG. 4B shows a hologram 24 symbolizing an open tailgate 14.

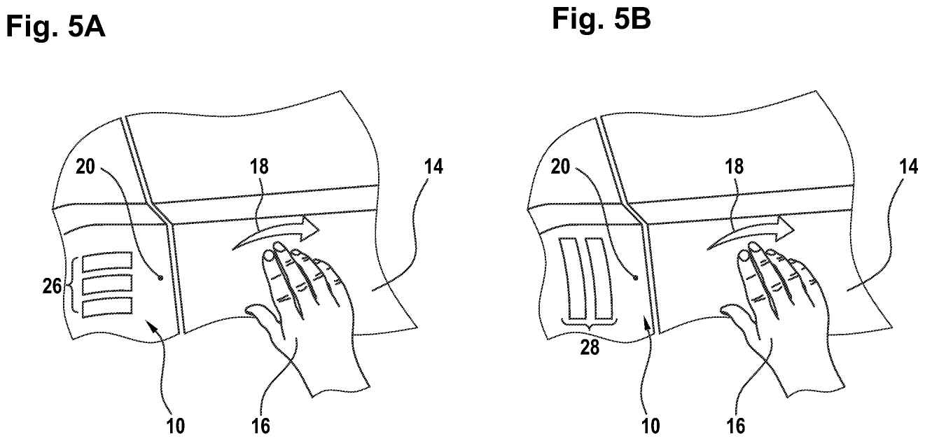

FIGS. 5A and 5B show a fifth exemplary embodiment. In this exemplary embodiment, the function triggered by a hand movement 18 consists in changing the appearance of a taillamp 10, i.e., in particular the shape of a light emission surface of the taillamp 10. In this context, FIG. 5A shows a light emission surface comprising three rather horizontal stripes 26. FIG. 5B shows an appearance changed by a hand movement 18, with a light emission surface comprising two rather vertical stripes 28, as an example of individual personalization.

In general, the invention can be used to trigger one or more functions, the functions including at least one of the following functions: opening/closing of the tailgate, activating/deactivating of the position light or the welcome function, personalizing of the taillamp signature, interacting with the light (e.g., dimming of the lamps depending on the distance of the hand to the taillamp), in the case of the mini LED display in the taillamp: displaying information, battery charge level, weather; switching on of the reversing light in order to illuminate the area behind the car, opening/closing of the vehicle windows.

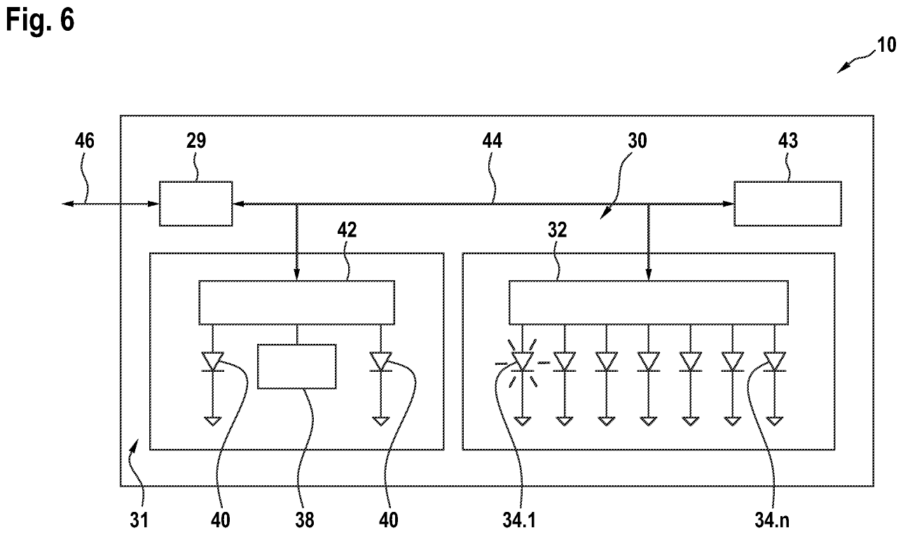

FIG. 6 shows an exemplary embodiment of an apparatus according to the invention in the form of a taillamp 10 as a block diagram of a basic implementation. The taillamp 10 has a taillamp light function module 30 for performing the signal light functions (tail, stop, turn, . . . ) and a gesture recognition module 31 for the gesture recognition and the HMI. The signaling functions are schematically represented by an LED driver 32 connected to a plurality of LEDs 34.1 to 34.n, while the gesture recognition module 31 consists of an optical infrared sensor 38, two (or more) infrared LEDs 40, and a sensor control unit 42. The driver 32 and the sensor control unit 42 are preferably combined in a single control device. A block 43 represents other optional functions.

An LED 34.1 of the LEDs 34.1 to 34.n of the taillamp light function that are configured to emit visible light flashes once to signal the position of the sensor 38, whereby a system and resource optimization is achieved. In addition, the complete taillamp light function is also used to acknowledge the successful recognition of a hand movement 18 to open or close the tailgate 14, e.g., by a swiping animation in one direction or the other. The sensor control unit 42 controls all infrared LEDs 40 according to a particular pattern and receives the corresponding feedback signal from the optical sensor 38.

The detected information is then transmitted via the internal data bus 44 to a microcontroller 29, which interprets the data and decides whether a hand movement 18 used to control a function has been recognized or not. If a hand movement 18 has been recognized, this decision is transmitted via the vehicle data bus 46 to the higher-level vehicle control device (body control module, BCM), which then triggers or performs the associated function. At least two infrared LEDs 40 are required to recognize one-dimensional gestures, and at least three are required to recognize two-dimensional gestures.

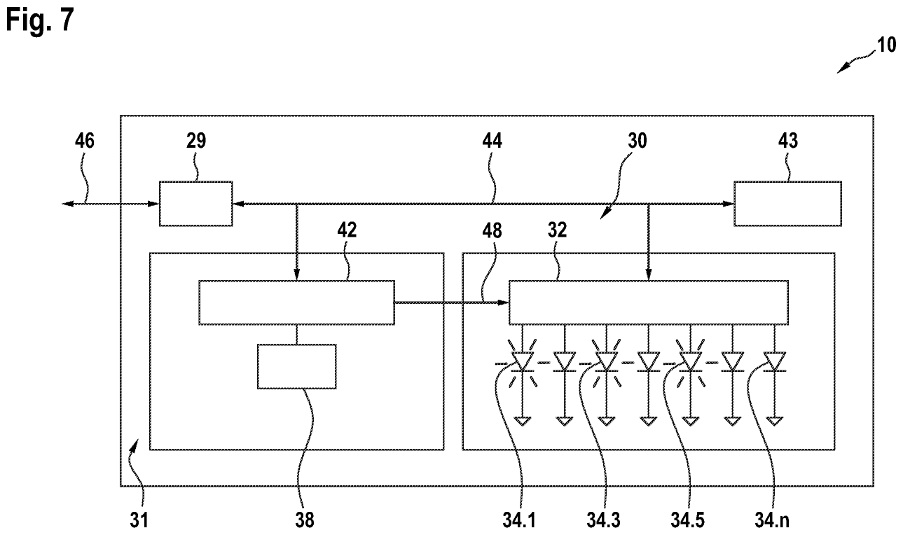

A very similar implementation to the one just explained is shown in FIG. 7, where LEDs 34.3 and 34.5 configured to emit visible light are used instead of the infrared LEDs 40 of FIG. 6. This has the advantage of achieving an even greater system and resource optimization, since the gesture sensor system LEDs are also used for the original light functions of the taillamp 10.

This exemplary embodiment has the disadvantage that a synchronization signal 48 from the sensor control unit 42 to the LED driver 32 is required to synchronize the alternating switching on of the LEDs 34.4, 34.5 and the light detection by the optical sensor 38.

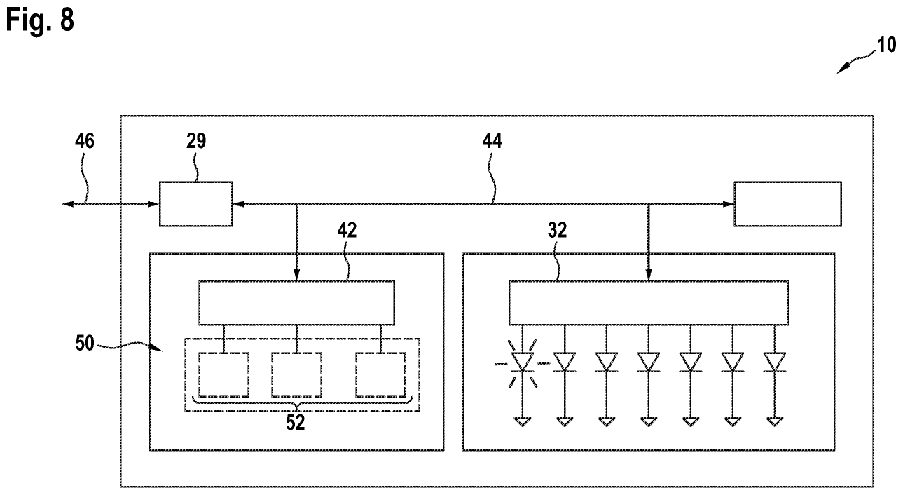

FIG. 8 shows an exemplary embodiment in which a capacitive sensor 50 is used instead of an optical sensor 38. The block diagram shows that the microcontroller 30 is still connected via an internal data bus 44 to the LED driver 32 of the standard functions and to the sensor control unit 42. The sensor control unit 42 is connected to two or more electrodes 52, which make it possible to detect fluctuations in capacitance. The detected data are transmitted to the microcontroller 30, which decides whether a gesture 18 has been performed or not. At least two electrodes 52 are required to recognize one-dimensional gestures, and at least three are required to recognize two-dimensional gestures. The larger the detection range, the larger the electrodes 52 have to be.

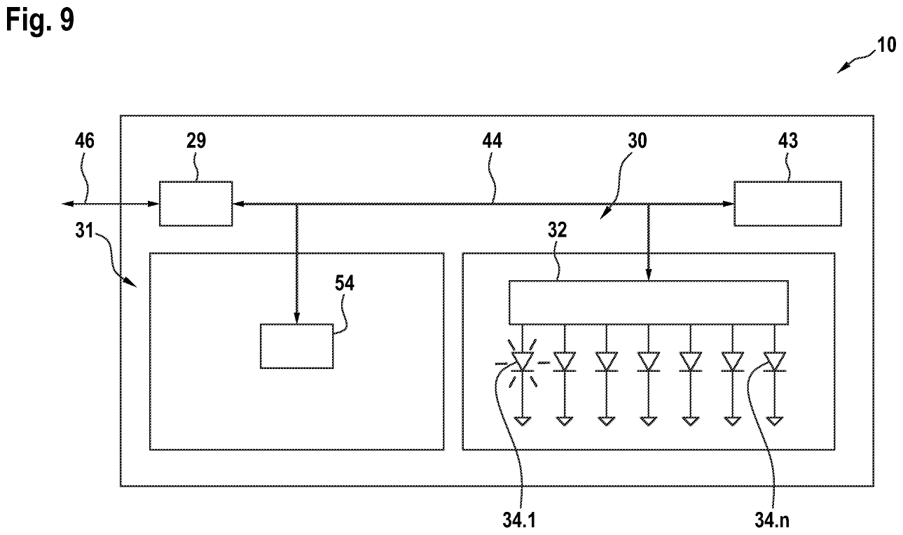

A final exemplary embodiment is shown in FIG. 9, where a time-of-flight sensor 54 is used. This is a particular family of optical sensors that can determine the distance of an object by measuring the time it takes for the light to leave a light source, be reflected by an object, and reach the time-of-flight sensor 54. The sensors of this family are very small (approx. 4×2 mm), and some of them comprise a plurality of detector zones accommodated in a small housing, so that a single time-of-flight sensor 54 can even be suitable for recognizing complex three-dimensional hand movements, though at the expense of a higher computing effort for sensor signal evaluation.

As an alternative to the implementation shown in FIG. 9, the time-of-flight sensor could be replaced by a radar, a camera, or a LiDAR sensor. In this case, the computing power required to process the sensor data and to extract the gesture information is considerably higher, but the complexity and accuracy of the recognized gestures can be significantly improved. This type of approach is particularly interesting if one of these sensors is already to be integrated into the taillamp (e.g., a cornering radar for recognizing blind spots). In this case, the software of the sensor must be updated in order to make gesture recognition possible.

In the exemplary embodiments shown in FIGS. 6 to 9, a plurality of semiconductor light sources lined up along a line is present in each case, which semiconductor light sources can be switched on sequentially for a short time in order to produce the optical effect of a swipe movement acknowledging the hand movement of the user, so that the impression of the swiping movement of a luminous spot, a luminous line, or a luminous surface is given. In addition to acknowledging the recognition of the gesture in this way, a function assigned to the hand movement is performed by the vehicle, e.g., the opening of a tailgate 14. The other display options can likewise be used for communication with the user, in particular for acknowledgment. This applies in particular to a mini-LED display, symbols, and holograms.

A complementary use is a closing of a tailgate 14. In this case, too, one or more semiconductor light sources are activated in one embodiment, for example in a flashing manner, in order to indicate the position of the sensor to the user. The user can then perform a closing gesture in the detection range of the sensor in order to initiate a closing of the trunk. The gesture can, for example, be a downward swipe movement of a hand of the user. After the gesture has been performed, one or more of the light sources already present for the light functions of the taillamp are used to signal to the user, by lighting up, that the gesture has been recognized. As in the case of the opening of the trunk, this can take place by switching on a plurality of semiconductor light sources, which are lined up along a line, sequentially for a short time in order to produce the optical effect of a swipe movement, so that the impression of the swiping movement is given. The order in which the semiconductor light sources are switched on for a short time is advantageously the reverse of that in the case of the gesture-controlled opening of the tailgate 14. In addition to acknowledging the recognition of the gesture in this way, the vehicle performs a function assigned to the gesture, here, for example, the closing of the tailgate. To this end, the vehicle's central control device (body control module), which controls such functions, sends a corresponding control command via the bus system of the vehicle to the actuator system of the trunk lid.

A sophisticated implementation of this technology would be able to recognize a plurality of different gestures performed in a plane or even in space and thus to realize a plurality of actions and interactions between the user and the vehicle. A list of possible use cases for such an implementation includes not only the opening and closing of the tailgate but also an activating/deactivating of the position light and/or of a welcome function that can be realized by a visual or acoustic effect, and/or a personalizing of the taillight signature (appearance of a light emission surface of the taillamps), and/or an interaction with the light (e.g., dimming of the lamps as a function of the distance of the hand to the taillamp). When using a mini LED display in the taillamp, the list of possible use cases furthermore includes a displaying of information, e.g., regarding the battery charge level and/or the weather, and/or a switching on of the reversing light in order to illuminate the area behind the car, and/or an opening/closing of the vehicle windows, and/or a locking and/or unlocking of the vehicle doors. For safety reasons, all these actions are only performed if the user performing the gestures also has the vehicle key (FOB). This safety feature is preferably implemented in/by the vehicle control device.

The integration of the gesture sensor technology in the taillamp makes a simple implementation of the human-machine interface possible through multiple use of the usual light functions of the taillamp (e.g., taillight, indicator light, etc.) and is also the ideal place to support the use case of the opening/closing of the tailgate. In order to support some of the alternative or complementary use cases in the list of possible use cases, other locations on the vehicle exterior may be equally or better suited to accommodate the gesture sensor system and the hardware required for the HMI (e.g., one or more light sources). Suitable locations could be: headlamps, central brake lamp, door handles, windows, or windshield, rear-view mirrors, or camera.

The invention has been described in an illustrative manner. It is to be understood that the terminology which has been used is intended to be in the nature of words of description rather than of limitation. Many modifications and variations of the invention are possible in light of the above teachings. Therefore, within the scope of the appended claims, the invention may be practiced other than as specifically described.

1. An apparatus for the contactless triggering of at least one function of a motor vehicle, the apparatus comprising a sensor system which is configured to recognize gestures of a user and which is configured to monitor at least a sub-area of an environment of the motor vehicle for a predetermined gesture being performed by a user of the motor vehicle and, if the sensor system recognizes a performance of the gesture, to trigger a performance of the function of the motor vehicle, wherein the gesture is a hand movement.

2. The apparatus as set forth in claim 1, wherein the function comprises a locking and/or unlocking of vehicle doors and/or vehicle windows and/or sunroofs, and/or an activating of welcome effects and/or farewell effects, and/or a switching on of a reversing lamp.

3. The apparatus as set forth in claim 1, wherein the function comprises an opening of a tailgate of the motor vehicle by an upward hand movement.

4. The apparatus as set forth in claim 1, wherein the function comprises a closing of the tailgate by a downward hand movement.

5. The apparatus as set forth in claim 1 comprising a lamp or a central brake lamp or door handles or windows or a windshield or a rear-view mirror, which comprises a gesture sensor system configured to recognize the hand movement.

6. The apparatus as set forth in claims 1 further comprising a motor vehicle taillamp which comprises a gesture sensor system configured to recognize the hand movement.

7. The apparatus as set forth in claim 6, configured to use semiconductor light sources of the motor vehicle taillamp in order to signal a position of the gesture sensor system.

8. The apparatus as set forth in claim 6 configured, after the hand movement, which may, for example, be an upward or downward swipe movement, has been recognized, to use one or more semiconductor light sources already present for taillamp light functions of the motor vehicle taillamp, in order to signal to the user, by lighting up the semiconductor light sources, that the hand movement has been recognized.

9. The apparatus as set forth in claim 8, wherein the taillamp comprises a plurality of semiconductor light sources lined up along a line, as light sources for the taillamp light functions, and in that the apparatus is configured to switch on a plurality of the plurality of semiconductor light sources sequentially for a short time in order to produce the optical effect of a swipe movement so that the impression of the swiping movement of a bright area is given.

10. The apparatus as set forth in claim 9, wherein the order in which the semiconductor light sources are switched on for a short time in the case of the gesture-controlled closing of the tailgate is the reverse of that in the case of the gesture-controlled opening of the tailgate.

11. The apparatus as set forth in claim 6 configured to use static symbols to signal the position of the gesture sensor system and to inform the user about the available gestures.

12. The apparatus as set forth in claim 11 further comprising a mini LED display which is integrated into the taillamp and which makes dynamic interaction with the user possible.

13. The apparatus as set forth in claim 11 configured to use static holographic 3D symbols to interact with the user.

14. The apparatus as set forth in claim 1, wherein the gesture sensor system comprises a camera and/or a radar sensor and/or a LiDAR sensor and/or a time-of-flight sensor.

15. The apparatus as set forth in claim 1, wherein the gesture recognition sensor system comprises an optical infrared sensor, at least two infrared light-emitting diodes, and a sensor control unit.

16. The apparatus as set forth in claim 1, wherein the gesture recognition sensor system comprises a sensor sensitive to visible light, at least two light-emitting diodes with which visible light can be emitted, and a sensor control unit.

17. The apparatus as set forth in claim 1, wherein the gesture recognition sensor system comprises a capacitive sensor.

18. The apparatus as set forth in claim 1 configured to recognize a plurality of different gestures and thus to make it possible to trigger a plurality of different functions of the motor vehicle to be performed.

19. The apparatus as set forth in claim 18, wherein the plurality of functions includes at least one of the following functions: opening/closing of the tailgate, activating/deactivating of the position light or the welcome function, personalizing of the taillamp signature, interacting with the light, in the case of the mini LED display in the taillamp: displaying information, battery charge level, weather; switching on of the reversing light in order to illuminate the area behind the car, opening/closing of the vehicle windows.
